(19) United States
(12) Patent Application Publication
(10) Pub. No.: US 2024/0086153 A1
(43) Pub. Date: Mar. 14, 2024

(54) MULTI-BIT ACCUMULATOR AND IN-MEMORY COMPUTING PROCESSOR WITH SAME

(71) Applicant: SAMSUNG ELECTRONICS CO., LTD., Suwon-si (KR)

(72) Inventors: Sungmeen MYUNG, Suwon-si (KR); Dong-Jin CHANG, Suwon-si (KR); Jaehyuk LEE, Suwon-si (KR); Daekun YOON, Suwon-si (KR); Seok Ju YUN, Suwon-si (KR)

(73) Assignee: SAMSUNG ELECTRONICS CO., LTD., Suwon-si (KR)

(21) Appl. No.: 18/467,521

(22) Filed: Sep. 14, 2023

Related U.S. Application Data
(63) Continuation of application No. 18/117,597, filed on Mar. 6, 2023.

(30) Foreign Application Priority Data
Sep. 14, 2022 (KR) 10-2022-0115784
Aug. 10, 2023 (KR) 10-2023-0105162

(51) Int. Cl. G06F 7/544; G06F 7/40

(52) U.S. Cl. CPC G06F 7/5443; G06F 7/405

(57) ABSTRACT

A multi-bit accumulator includes 1-bit Wallace trees each configured to perform an add operation on single-bit input data, tristate logic circuits each configured to output a result of the add operation of the 1-bit Wallace trees according to an enable signal provided to the tristate logic circuits, and a shift-adder configured to perform an accumulation operation on the result of the add operation of the 1-bit Wallace trees by a shift operation based on a clock signal.

### CROSS-REFERENCE TO RELATED APPLICATIONS

This application claims the benefit under 35 USC § 119(a) of Korean Patent Application No. 10-2022-0115784 filed on Sep. 14, 2022, and Korean Patent Application No. 10-2023-0105162 filed on Aug. 10, 2023, in the Korean Intellectual Property Office, the entire disclosures of which are incorporated herein by reference for all purposes. This application also claims priority to, and is a Continuation of, U.S. patent application Ser. No. 18/117,597, filed Mar. 6, 2023 in the U.S. Patent and Trademark Office, the entire disclosure of which is incorporated herein by reference for all purposes.

### BACKGROUND

### 1. Field

The following description relate to a multi-bit accumulator, an in-memory computing (IMC) processor including the multi-bit accumulator, and a method of operating the multi-bit accumulator.

### 2. Description of Related Art

Deep neural networks (DNNs) are widely used, leading to an artificial intelligence (AI)-based industrial revolution. Convolutional neural networks (CNNs), which are one type of DNN, are widely used in various applications, such as image and signal processing. CNNs may perform object recognition, computer vision, and the like. In some instances, implementation of a CNN may include repeatedly performing a multiplication and accumulation (MAC) operation on numerous matrices.

For example, when a CNN is executed by a general-purpose processor, operations that require a great amount of computation but are not complex may be performed through in-memory computing rather than by the general-purpose processor. For example, MAC operations, which involve computing a dot product of two vectors and accumulating and adding up the resulting values may be performed through in-memory computing (IMC), a type of memory device that perform computation on stored in the memory without necessarily having to move the data in and out of the memory device just to perform the computation.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a multi-bit accumulator includes: 1-bit Wallace trees each configured to perform an add operation on single-bit input data; tristate logic circuits each configured to output a result of the add operation of the 1-bit Wallace trees, according to an enable signal provided to the tristate logic circuits; and a shift-adder configured to perform an accumulation operation on the result of the add operation of the plurality of 1-bit Wallace trees by a shift operation based on a clock signal.

Each of the 1-bit Wallace trees may include an adder array including full adders, the full adders being used in a final operation stage among operation stages of the add operation. Each adder array may include: first-type full adders in which a tristate logic circuit is connected to an add operation result of an add operation between the single-bit input data; and a second-type full adder in which a tristate logic circuit is connected to each of an add operation result corresponding to an operation result of the final operation stage and a carry operation result generated in response to the add operation result.

Each of the tristate logic circuits may be configured to: output a high-impedance state, in response to the enable signal having a first logical value; and output the result of the add operation of the 1-bit Wallace trees to the shift-adder, in response to the enable signal having a second logical value opposite to (inverse of) the first logical value.

The multi-bit accumulator may further include: a logic gate configured to, in response to the multi-bit accumulator performing a signed operation on signed data, perform a logical operation between the signed data and a most significant bit (MSB) in a result of the accumulation operation of the shift-adder.

The logic gate may include: an XOR gate configured to perform an XOR operation between the MSB and the signed data.

The multi-bit accumulator may further include a signal generator configured to generate the enable signal that enables the tristate logic circuits by inverting the clock signal.

The 1-bit Wallace trees may be configured to operate according to the enable signal having the first logical value, and the shift-adder may be configured to operate according to the enable signal having the second logical value opposite to (inverse of) the first logical value.

The multi-bit accumulator may further include a registers configured to store output values of the 1-bit Wallace trees, respectively, according to the clock signal, to provide a pipelining operation between the 1-bit Wallace trees and the shift-adder by transmitting the stored output values to the shift-adder.

The registers may be implemented by a parasitic capacitance generated by the tristate logic circuits.

The multi-bit accumulator may further include a multiplier, and the transmitting may enable the 1-bit Wallace trees to perform the add operation concurrently with a multiplication operation of the multiplier.

In another general aspect, an in-memory computing (IMC) processor includes: an IMC device including a IMC macros, each IMC macro including a columns in a cross-bar structure; an input controller configured to sequentially input multi-bit first values to the IMC device bit by bit; and a post operation circuit configured to output a multi-bit operation result that integrates operation results of the respective IMC macros. Each of the IMC macros may include: a memory array including a bit cells, each bit cell configured to store a second value applied to each of the first values; a binary gate array including operation gates, each operation gate configured to perform a single-bit multiplication and accumulation (MAC) operation between the first values and the second value; and a multi-bit accumulator configured to perform a bit-wise operation on results of the single-bit MAC operation and perform an accumulation operation on a result of the bit-wise operation corresponding to any one of the columns, through a shift operation based on a clock signal.

The multi-bit accumulator may include: a 1-bit Wallace trees each configured to perform the bit-wise operation on the results of the single-bit MAC operation; a tristate logic circuits each configured to output a result of the bit-wise operation of a respective one of the 1-bit Wallace trees, according to an enable signal; and a shift-adder configured to perform an accumulation operation on a result of an add operation of a respective one of the 1-bit Wallace trees corresponding to any one of the columns by the shift operation based on the clock signal.

Each of the 1-bit Wallace trees may include: an adder array including full adders used in a final operation stage among operation stages of the add operation. The adder array may include: a first-type full adders in which a tristate logic circuit is connected to the results of the single-bit MAC operation; and a second-type full adder in which a tristate logic circuit is connected to each of an add operation result corresponding to an operation result of the final operation stage and a carry operation result generated in response to the add operation result.

The tristate logic circuits may be configured to: output a high-impedance state, in response to the enable signal having a first logical value; and output the result of the bit-wise operation of the 1-bit Wallace trees to the shift-adder, in response to the enable signal having a second logical value opposite to (inverse of) the first logical value.

The IMC processor may further include: a logic gate configured to, in response to the multi-bit accumulator performing a signed operation on signed data, perform a logical operation between the signed data and an MSB in a result of the accumulation operation of the shift-adder.

The logic gate may include an XOR gate configured to perform an XOR operation between the MSB and the signed data.

The IMC processor may further include a signal generator configured to generate the enable signal that enables the tristate logic circuits by inverting the clock signal.

The 1-bit Wallace trees may be configured to operate according to the enable signal having a first logical value, and the shift-adder may be configured to operate according to the enable signal having a second logical value opposite to (inverse of) the first logical value.

The IMC processor may be integrated into at least one of: a mobile device, a mobile computing device, a mobile phone, a smartphone, a personal digital assistant (PDA), a fixed location terminal, a tablet computer, a computer, a wearable device, a laptop computer, a server, a music player, a video player, an entertainment unit, a navigation device, a communication device, a global positioning system (GPS) device, a television (TV), a tuner, a vehicle, a vehicle part, an avionics system, a drone, a multicopter, or a medical device.

In another aspect, a method of operating a multi-bit accumulator includes: receiving single-bit input data; performing a 1-bit unit add operation on the input data; outputting results of the 1-bit unit add operation based on an enable signal; and outputting a result of a multi-bit operation corresponding to the input data by shifting and accumulating the results of the 1-bit unit add operation.

The outputting of the results of the 1-bit unit add operation may include: outputting a high-impedance state in response to the enable signal having a first logical value; and outputting a result of an add operation of 1-bit Wallace trees to a shift-adder in response to the enable signal having a second logical value opposite to the first logical value.

The method may further include: in response to the multi-bit accumulator performing a signed operation on signed data, performing a logical operation between the signed data and an MSB in a result of the multi-bit operation.

Other features and aspects will be apparent from the following detailed description, the drawings, and the claims.

### BRIEF DESCRIPTION OF THE DRAWINGS

FIG. 1 illustrates an example multi-bit accumulator, according to one or more example embodiments.

FIGS. 2A and 2B illustrate an example of a multi-bit accumulator in an in-memory computing (IMC) device, according to one or more example embodiments.

FIG. 3A illustrates example structure of a multi-bit accumulator and an example operation of a 1-bit Wallace tree included in the multi-bit accumulator, according to one or more example embodiments.

FIG. 3B illustrates an example of toggling occurring in a 1-bit Wallace tree, according to one or more example embodiments.

FIG. 3C illustrates example timing of a multi-bit accumulator, according to one or more example embodiments.

FIG. 4 illustrates example operation of a tristate logic circuit, according to one or more example embodiments.

FIG. 5 illustrates example structure of a multi-bit accumulator configured to perform a signed operation, according to one or more example embodiments.

FIG. 6 illustrates example structure of a multi-bit accumulator including an adder array, according to one or more example embodiments.

FIG. 7 illustrates an example circuit of an adder array, according to one or more example embodiments.

FIG. 8 illustrates an example circuit of a first-type full adder and a second-type full adder included in an adder array, according to one or more example embodiments.

FIG. 9A illustrates an example pipelining operation of a multi-bit accumulator to which a tristate logic circuit is applied, according to one or more example embodiments.

FIG. 9B illustrates an example in which a parasitic capacitance is generated in a multi-bit accumulator, according to one or more example embodiments.

FIG. 10A illustrates an example of performing a row-add operation by a Wallace tree and a shift-add operation by a shift-adder through pipelining in a multi-bit accumulator, according to one or more example embodiments.

FIG. 10B illustrates an example clock control operation performed when a multi-bit accumulator operates in a toggle prevention mode and in a pipeline mode, according to one or more example embodiments.

FIG. 11 illustrates an example method of operating a multi-bit accumulator, according to one or more example embodiments.

FIG. 12 illustrates an example relationship between operations performed in an IMC macro and a neural network, according to one or more example embodiments.

FIG. 13 illustrates an example IMC processor including a multi-bit accumulator, according to one or more example embodiments.

FIG. 14 illustrates example structure of an IMC processor, according to one or more example embodiments.

FIG. 15 illustrates an example electronic system including an IMC processor, according to one or more example embodiments.

Throughout the drawings and the detailed description, unless otherwise described or provided, the same or like drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

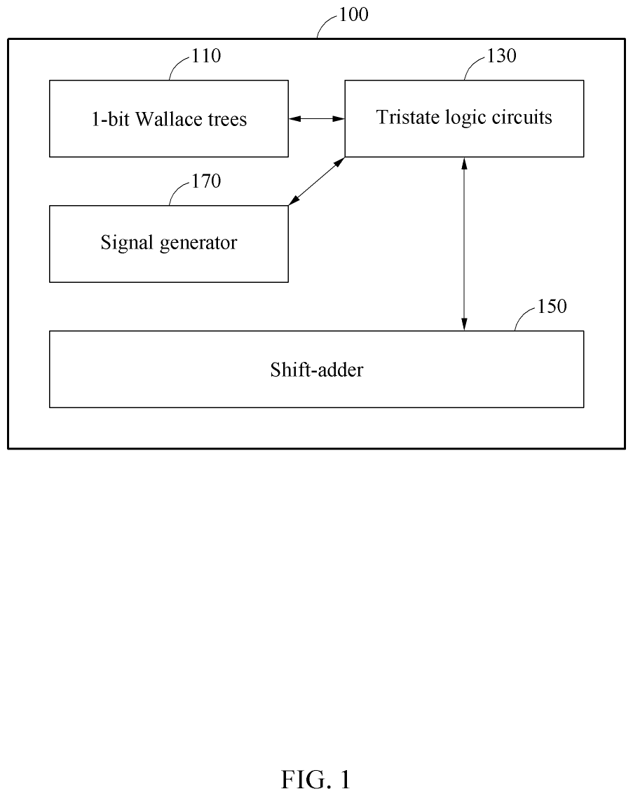

FIG. 1 illustrates an example multi-bit accumulator, according to one or more example embodiments. Referring to FIG. 1, a multi-bit accumulator 100 according to an example embodiment may include 1-bit Wallace trees 110, tristate logic circuits 130, and a shift-adder 150. The multi-bit accumulator 100 may further include a signal generator 170.

The 1-bit Wallace trees 110 may perform an add operation on pieces of input data that contain a single-bit, e.g., single-bit input data. A single bit may refer to 1 bit. Hereinafter, the terms “single bit” and “1-bit” may be understood to have the same meaning. For example, a single bit of data that is bitstreamed as input into an IMC device.

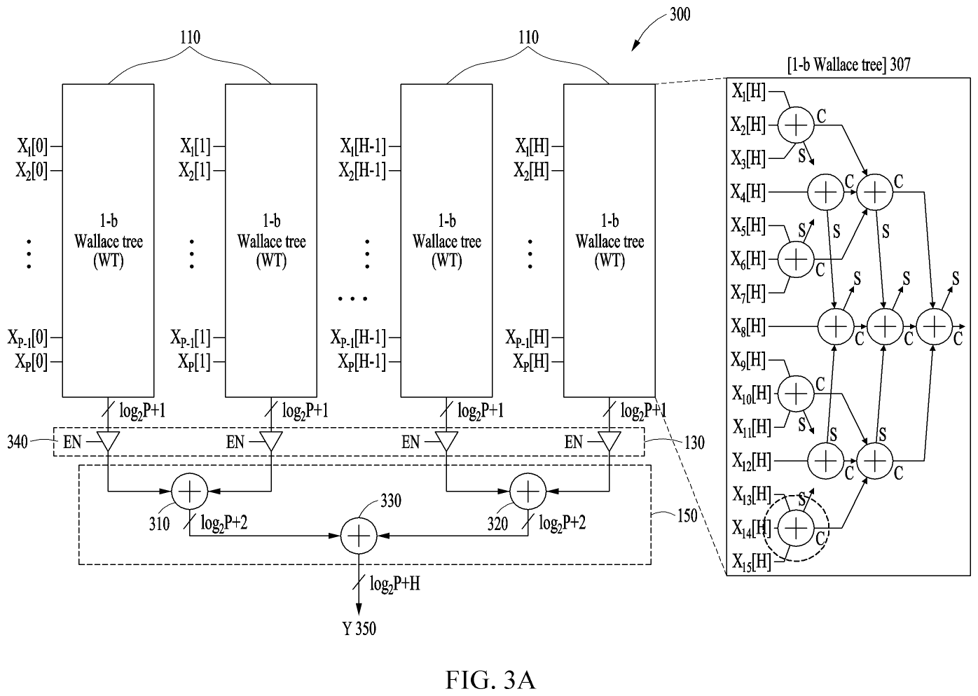

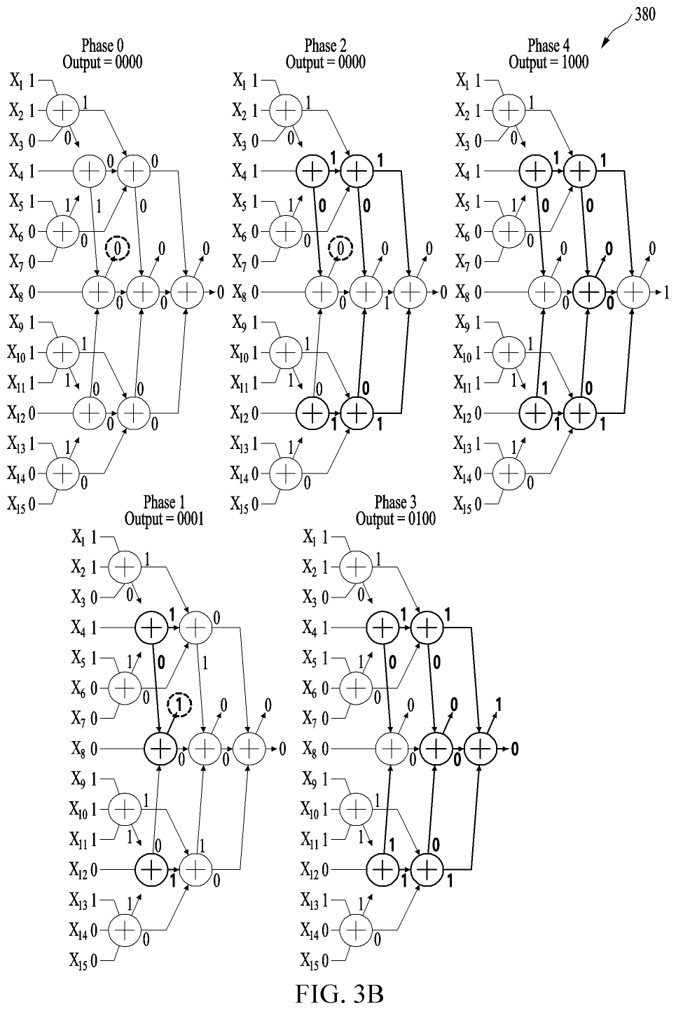

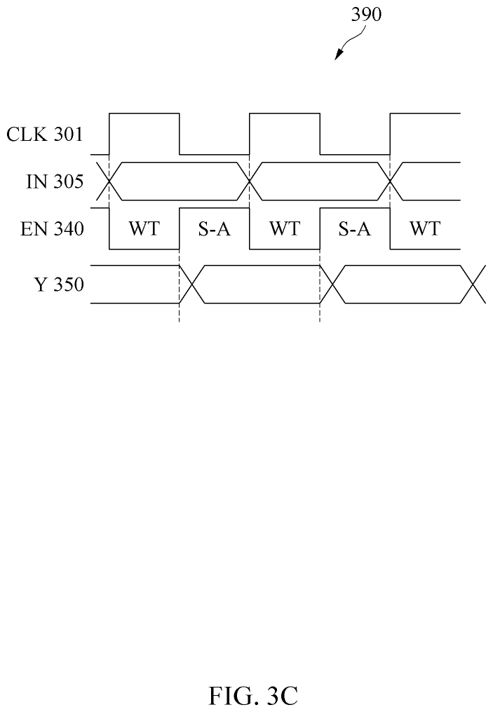

A method of operating the 1-bit Wallace trees 110 is described with reference to FIGS. 3A through 3C.

A structure and operation timing of the multi-bit accumulator 100 is described with reference to FIGS. 3B and 3C.

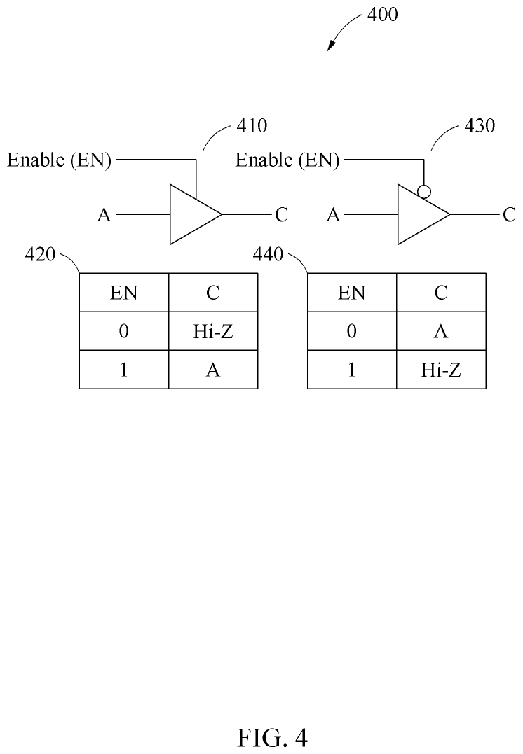

The tristate logic circuits 130 may output a result of the add operation (or “add operation result”, as used herein) of the 1-bit Wallace trees 110 according to an enable (EN) signal generated by the signal generator 170. The tristate logic circuits 130 may be, for example, tristate buffers, or switch devices that operate in three states similarly to tristate buffers. The output of the tristate logic circuits may depend on the enable signal EN provided thereto. For example, the tristate logic circuits 130 may output a high impedance state when the enable signal EN supplied thereto has a first logical value (e.g., a zero (0) value). the phrase “high impedance state” refers to a state, at a point in a circuit, where a relatively small amount of current per voltage unit that is applied to the point in the circuit passes. The numerical definition of “high impedance” may vary depending on an application. Conversely, when the enable signal EN has a second logical value (e.g., a one (1) value), the tristate logic circuits 130 may output, to the shift adder 150, whatever is the add operation result of the 1-bit Wallace trees 110. A method of operating the tristate logic circuit(s) 130 is described with reference to FIG. 4.

Within the multi-bit accumulator 100, the 1-bit Wallace trees 110 may have operative effect when the enable signal EN has the first logical value (e.g., 0). However, it may be the shift-adder 150 that has operative effect when the enable signal EN has the second logical value (e.g., 1).

The shift-adder 150 may perform an accumulation operation on the add operation result of the 1-bit Wallace trees 110. Specifically, the shift-adder 150 may perform a shift operation based on a clock (CLK) signal. A relationship between the clock signal CLK and the enable signal EN is described with reference to FIG. 3C.

For example, where the multi-bit accumulator 100 performs a signed operation on signed data, the multi-bit accumulator 100 may further include a logic gate that performs a logical operation between (i) the signed data and (ii) a most significant bit (MSB) of a result of the accumulation operation (or an “accumulation operation result” herein) of the shift-adder 150. The logic gate may include, for example, an XOR gate that performs an XOR operation (or a multiplication operation) between the signed data and the MSB of the accumulation operation result of the shift-adder 150.

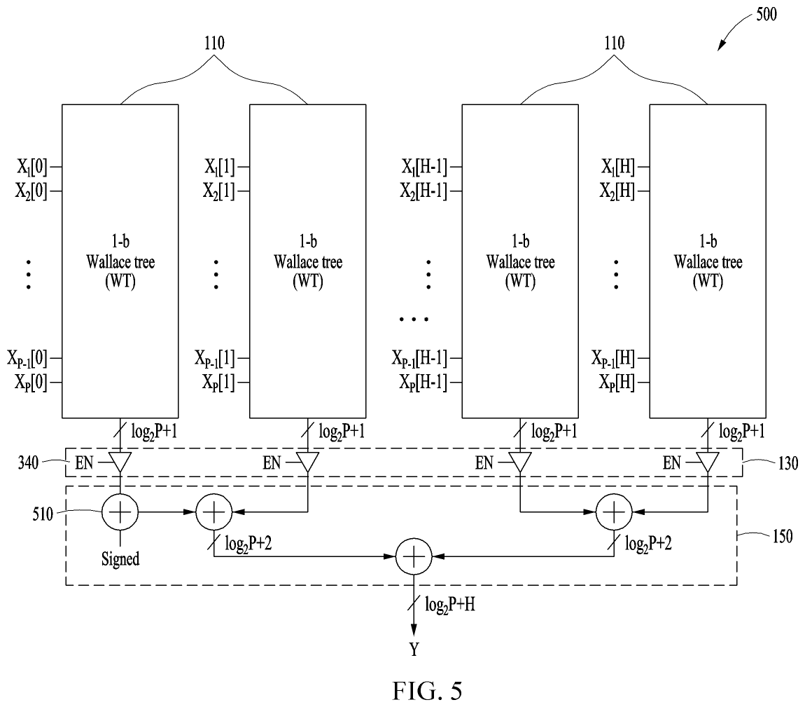

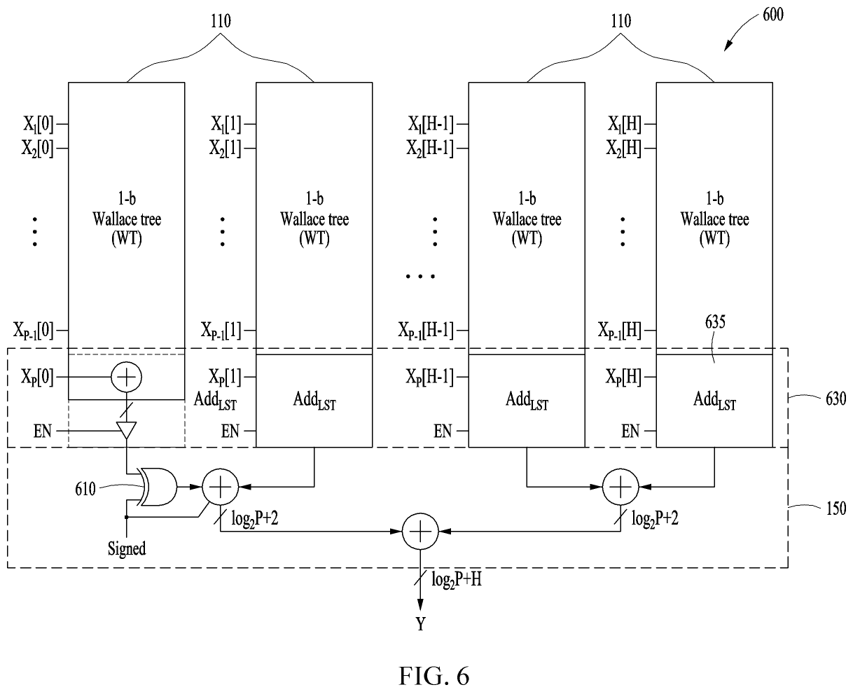

A structure and operation of the multi-bit accumulator 100 performing the signed operation on signed data is described with reference to FIGS. 5 and 6.

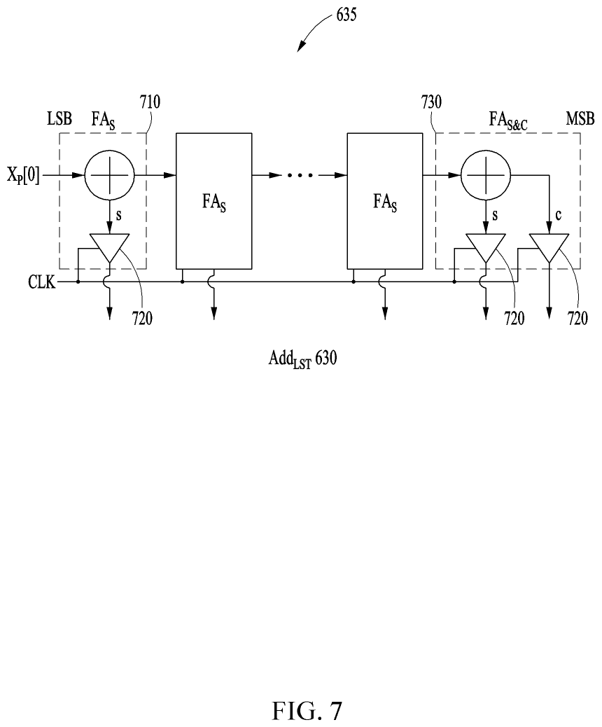

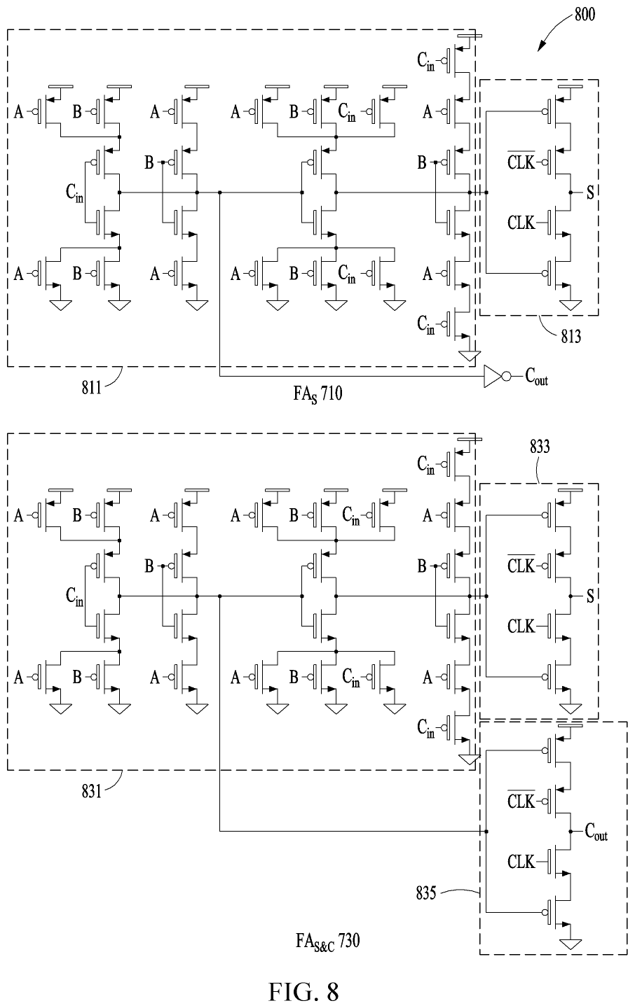

The 1-bit Wallace trees 110 may include respective adders of an adder array (e.g., an adder array 630 of FIG. 6). The adder array may include full adders used in multiple operation stages for an add operation. The adders of the adder array may include, for example, first-type full adders and second-type full adders. For the first-type full adders (e.g., a full adder 710 of FIG. 8), a tristate logic circuit (e.g., a tristate logic circuit 813 of FIG. 8) connects to an add operation result (a sum S) between the pieces of the single-bit (or 1-bit) input data. For the second-type full adder (e.g., a full adder 730 of FIG. 8), a tristate logic circuit (e.g., a tristate logic circuit 833 and a tristate logic circuit 835 of FIG. 8) connects to (i) an add operation result (a sum S) corresponding to an operation result of a final operation stage among multiple operation stages and to (ii) a result of a carry operation (or a carry operation result C herein) generated according to the add operation. A structure and circuit of the adder array is described in with reference to FIGS. 7 and 8.

The signal generator 170 may generate the enable signal EN that enables the tristate logic circuits 130 by inverting the clock signal CLK.

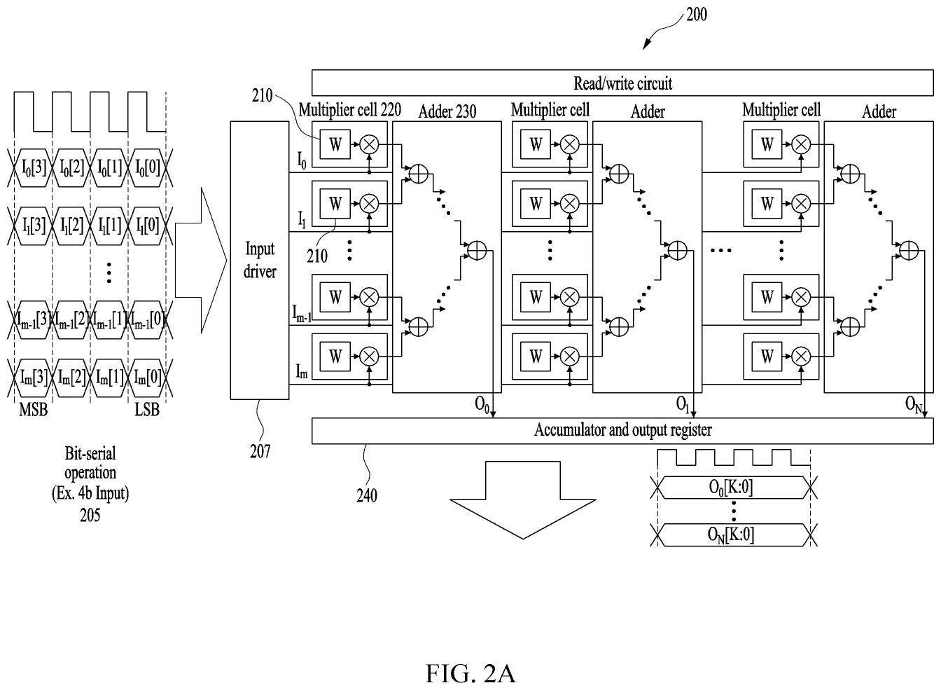

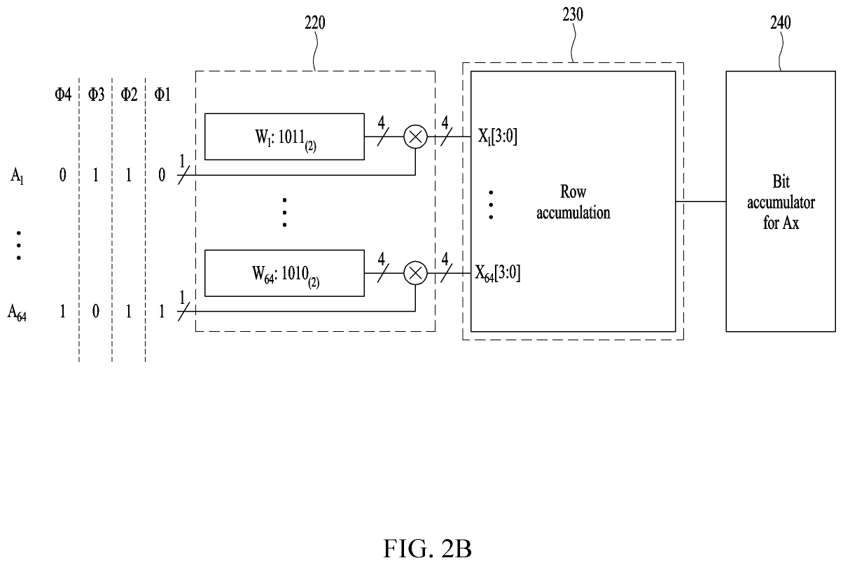

FIGS. 2A and 2B illustrate an example use of a multi-bit accumulator in an in-memory computing (IMC) device, according to one or more example embodiments.

FIG. 2A shows an example case in which a multi-bit accumulator is used as an adder 230 of an IMC device 200. The IMC device 200 may be, for example, a digital IMC device but is not limited thereto.

The digital IMC device 200 may include a memory cell 210, a multiplier cell 220, and the adder 230.

The memory cell 210 may include static random-access memory (SRAM) bit cells that store weight values W, for example (although weights and other neural network data are mentioned herein, such data is only an example and other types of data may be used). The memory cell 210 may be configured as a 6 transistor (T), 8T, and 12T SRAM but is not limited thereto.

The multiplier cell 220 may perform a multiplication operation between (i) input data 205 that is sequentially applied bit-by-bit through an input driver 207 and (ii) the weight values stored in the memory cell 210. The input data 205 may be sequentially input bit-by-bit according to a time sequence from a least significant bit (LSB) to the MSB of the input data 205. The multiplier cell 220 may output, to the adder 230, a result of the multiplication operation (also referred to as a “multiplication operation result”) between 1-bit input values and the weight values stored in the memory cell 210. The adder 230 may perform an add operation on multiplication operation results received from multiplier cells column 220. The adder 230 may perform the add operation using a full adder and/or half adder, for example. The multiplication operation results output from the adder 230 may be finally accumulated and output through an accumulator and output register 240.

The multi-bit accumulator according to an example embodiment may perform an operation of the adder 230 or operations of the adder 230 and the accumulator and output register 240.

FIG. 2B shows an example multiplication and accumulation (MAC) operation method performed when, for example, 64 pieces of 4-bit input data 205 are applied bit by bit to the multiplier cell 220 and a 4-bit weight is stored in the memory cell 210 in the multiplier cell 220.

The 64 pieces of input data 205 may be sequentially input bit by bit to the multiplier cell 220 according to a time sequence. In this case, the multiplier cell 220 may include 64 memory cells 210. When the 64 pieces of input data 205 are sequentially input bit by bit, a multiplication operation between 1-bit input data and the 4-bit weight may be performed for each multiplier cell 220. Accordingly, a 4-bit multiplication operation result may be output for each multiplier cell 220. The adder 230 may group together 4-bit multiplication operation results output from multiplier cells 220 to perform an add operation thereon. An add operation result of the adder 230 may be accumulated and output bit-by-bit in the accumulator and output register 240.

In this case, the adder 230 may be in the form of 64 columns of 4-bit adders including four full adders. In addition, one bit for a sign that expresses negative values or numbers in actual operations may be further used, and thus a full adder that is added to the adder 230 for a signed data operation for negative values or numbers may be considered and a total of 372 full adders may thus be used. In addition, a ripple carry adder, which is the slowest form for a small area, may be used but may generate a delay of a maximum of 16 full adders.

FIG. 3A illustrates example structure of a multi-bit accumulator, according to one or more example embodiments. FIG. 3A shows a structure of a multi-bit accumulator 300.

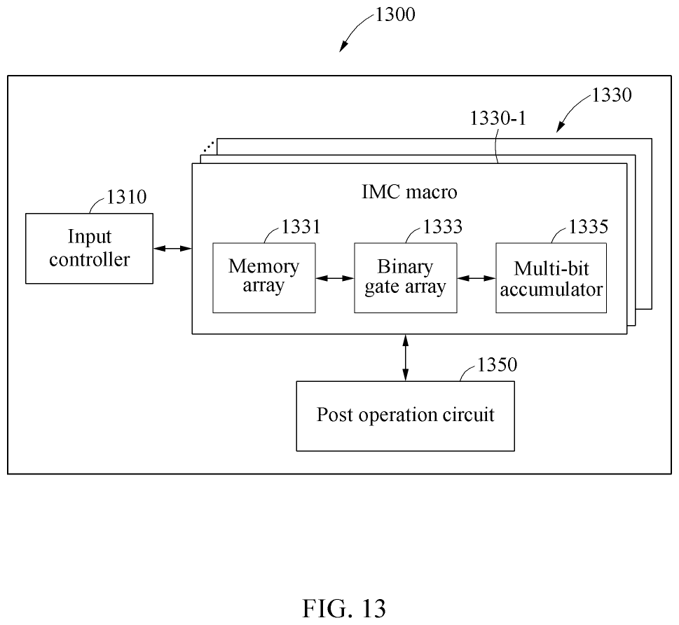

The multi-bit accumulator 300 may include, for example, 1-bit Wallace trees 307 included in a plurality of IMC macros (e.g., a plurality of IMC macros 1330-1 of FIG. 13), each including a plurality of columns in a crossbar structure. In this case, the plurality of IMC macros (each including a plurality of columns in the crossbar structure) may perform, for example, a vector matrix multiplication operation and generally perform a MAC operation. For example, each of the columns may include P bit cells B₁ to B_{P}, and the MAC operation may be performed by the P bit cells of each column. For example, a multiplication operation may be performed in each bit cell unit together with an input, and an accumulation operation may be performed in a column unit. The 1-bit Wallace trees 307 may each correspond to the respective columns.

In an IMC macro, an operation on multi-bit input data and a weight may be performed, for example, in a manner where an H-bit weight and 1-bit input data may be multiplied, and then H-bit S_{N}[H:1] corresponding to a result of the multiplication may be added by the multi-bit accumulator 300. Such an operation may be repeatedly performed H times by changing a bit position of the input data, and the MAC operation on the H-bit input data and the H-bit weight may then be completed.

For example, when the multi-bit accumulator 300 performs an add operation on a 4-bit multiplication result of the H-bit weight and the 1-bit input data, 4-bit input data may be input to the multi-bit accumulator 300.

In addition, a signed operation on signed data may use a sign extension to process the signed data which may result in the use of one more full adder for the signed operation since there is a 1 bit increase in each stage to process overflows. The term “sign extension” refers to an operation of increasing the number of bits of a binary number while maintaining a sign and a value of the number represented by the binary number in the operation process. The sign extension may be used, for example, when a signed number such as a negative number or value is extended and may be performed by including an MSB value in the extended bit. Where this additional full adder is used for the sign extension, the number of full adders being employed may consume a large area, which may also increase the area of the IMC macro. Accordingly, in an example, the multi-bit accumulator 300 based on the 1-bit Wallace tree may improve an area efficiency of an adder tree in the IMC macro.

Since each of the 1-bit Wallace trees 307 may apply input data to a carry-in port of a full adder, a small number of full adders may be used to perform an accumulation operation on a large amount of the input data.

A 1-bit Wallace tree 307 circuit may be configured to facilitate an operation of an arbitrary bit number by combining a set of full adders. The symbol [symbol] shown in FIG. 3A represents a full adder.

The 1-bit Wallace tree 307 may configure each bit with a full adder and use the second digit of a previous digit of the full adder as a carry digit of a next digit, that is, as a carry. This may correspond to the same operation as performing calculations for each digit and rounding up each digit during addition. The 1-bit Wallace tree 307 may enable a high-speed operation by performing a partial sum among operands and reducing the number of stages. The 1-bit Wallace tree 307 may perform an add operation by grouping three pieces of input data each for a partial sum among the operands. When the number of pieces of the input data is less than three, the 1-bit Wallace tree 307 may transfer the pieces of the input data to a next stage such that the partial sum may be performed in the next stage. For example, when there are two of a sum S and a carry C left in a result of the partial sum, the 1-bit Wallace tree 307 may, for example, cause the add operation of a final operation stage to be performed by a carry propagation adder (CPA) 370, which operates in a manner similar to that of a ripple carry adder.

In a second operation stage, the 1-bit Wallace tree 307 may calculate a single-digit binary number including a lower carry input (e.g., Carry in (Ci)). The 1-bit Wallace tree 307 may add a total of three bits including one 1-bit carry input Ci and two 1-bit operands and output a sum S and a carry output Co. The 1-bit Wallace tree 307 may perform a calculation including a lower carry and may thus perform n-digit binary addition.

The logical formula of the 1-bit Wallace tree 307 may be expressed as Equation 1 below.

Co=A·B+Ci(A⊕B), Sum=A⊕B⊕Ci Equation 1

In Equation 1, A and B denote 2-bit operands and Ci denotes a carry input. Co denotes a carry output, and Sum denotes a binary addition result.

When a sum operation is performed on 15 operands as shown in FIG. 3A, for example, a carry output Cout and a final addition result Sum may be output through five operation stages (stage 0 to stage 4). The term “operation stage” or “stage” used herein refers to an operation stage performed through one full adder.

However, the 1-bit Wallace tree 307 may have a different logic depth for each input data, and unnecessary output toggling may occur as described above. The output toggling occurring in the 1-bit Wallace tree 307 is described with reference to FIG. 3B.

In an example, to prevent this unnecessary toggling from occurring, in an adder array, a full adder that generates a final output of a Wallace tree, that is, an operation result of the final operation stage, may connect the tristate logic circuits 130 to an add operation result (Sum) and a carry output (Carry out). The multi-bit accumulator 300 may prevent the unnecessary output toggling by enabling the tristate logic circuits 130 to output an operation result or a high impedance state according to an enable signal EN 340.

The multi-bit accumulator 300 may correspond to, for example, an adder tree, but is not limited thereto.

The multi-bit accumulator 300 may include the 1-bit Wallace trees 110 for performing an add operation first on P pieces of 1-bit input data X₁ to X_{P}. In this case, the tristate logic circuits 130, which output an add operation result of the 1-bit Wallace trees 110, may be added to adders in the final operation stage of the Wallace trees 110, according to the enable signal EN 340.

The shift-adder 150 may output Y 350, which is a result of performing a shift operation and an add operation on outputs of the tristate logic circuits 130. The shift-adder 150 may include, for example, a full adder 310, a full adder 320, and a full adder 330. The full adder 310 performs a first add operation on outputs of tristate logic circuits 130 connected to two 1-bit Wallace trees corresponding to a first column and a second column among the total four 1-bit Wallace trees 110. The full adder 320 performs a second add operation on outputs of tristate logic circuits 130 connected to two 1-bit Wallace trees corresponding to a third column and a fourth column. And, the full adder 330 performs an add operation of the first add operation and the second add operation. An operation result of the full adder 310 and an operation result of the full adder 320 may each have log₂ P+2 bits, and an operation result Y 350 of the full adder 330 may have log₂ P+H bits.

In this case, the shift operation on the outputs of the tristate logic circuits 130 may be performed by the full adder 310 and the full adder 330. For example, it is assumed that an add operation is performed between A (4 bits) of the full adder 310 and B (4 bits) of the full adder 330. In this case, when no shift operation is performed, when A3 (MSB of A), A2, A1, and A0 (LSB of A) are added to B3 (MSB of B), B2, 1, and B0 (LSB of B), A0 may be added to B0 first and a carry generated at this time may be added together with A1 and B1 when they are added. An add operation process when no shift operation is performed may be expressed by signs as follows:
(A0+B0): Sum S 0, Carry C 0 generation
(A1+B1)+C0: S1, C1 generation
(A2+B2)+C1: S2, C2 generation
(A3+B3)+C2: S3 generation.

Contrary to this, an add operation process when the shift operation is performed (e.g., where A is shifted by 1-bit than B) may be expressed by signs as follows:
B0: S0 generation
(A0+B1): S1, C1 generation
(A2+B2)+C1: S2, C2 generation
(A1+B3)+C2: S3, C3 generation
(A2)+C3: S4 generation.

To summarize, the multi-bit accumulator 300 may perform an accumulation operation on multi-bit input data through the structure shown in FIG. 3A.

FIG. 3B illustrates an example of toggling occurring in a 1-bit Wallace tree, according to one or more example embodiments. FIG. 3B shows an example 380 of an operation of a 1-bit Wallace tree 307 that performs an add operation on 15 operands from R₁ to R₁₅.

The 1-bit Wallace tree 307 may implement an adder using a small number of full adders. However, a path delay may occur and the delay may vary depending on the input data. For example, data “1,1,0,1,1,0,0,0,1,1,1,0,1,0,0” on 15 operands from X₁ to X₁₅ may be input in phase 0. The pieces of input data may be applied to four full adders each including three inputs and to X₄, X₈, and X₁₂. In this case, data “1” of X₄, data “0” of X₃, and data “0” of X₁₂ may be calculated together with an add operation in the four full adders in phase 1.

In phase 0, the 1-bit Wallace tree 307 may sequentially output “0000” through a path connected to X₈.

In phase 1, data “1” of X₄, data “0” of X₃, and data “0” of X₁₂ may be calculated (e.g., add operation) together with a carry C and an addition result (or sum) S generated in the four full adders receiving the three pieces of input data in phase 0. Accordingly, an addition result S of X₄ which was “0” in phase 0 may be changed to “1,” and an addition result S of X₁₂ which was “0” in phase 0 may be changed to “1.” The 1-bit Wallace tree 307 may output “0001.”

In phase 2, the carry C and the addition result S generated in phase 1 may be transferred to three full adders and calculated (e.g., add operation) therein. Accordingly, the carry of X₈ which was “1” in phase 1 may be changed to “0” again in phase 2, and the 1-bit Wallace tree 307 may output “0000.”

In phase 3, the carry C and the addition result S generated in phase 2 may be transferred to one full adder and calculated (e.g., add operation) therein. Accordingly, the 1-bit Wallace tree 307 may output “0100” in phase 3.

In phase 4, the carry C and the addition result S generated in phase 3 may be transferred to one full adder and calculated (e.g., add operation) therein. Accordingly, the 1-bit Wallace tree 307 may output “0100” in phase 4.

As described above, data “1” of X₄ may be output as a carry C and a final addition result S through the four full adders in phase 0 to phase 4. In addition, data “0” of X₃ may be output as a carry C and a final addition result S through the three full adders. In this case, when using the 1-bit Wallace tree 307, there may be toggling in which an output is changed, for example, “0000”→“0001”→“0000”→“0100”→“1000,” each time a new input is applied as a path delay varies according to an input path. That is, although output data “1000” may be output in response to input data “0000” in the same manner, toggling in which an output value is changed in its intermediate process may occur.

Due to the toggling occurring in an output of the 1-bit Wallace tree 307, the same toggling phenomenon may occur in an output of a shift-adder that performs an accumulation operation on add operation results of 1-bit Wallace trees. The toggling phenomenon may increase a computational amount (or an operation amount) and may thus increase power consumption.

However, in some examples, the use of a tristate buffer, as described with reference to FIG. 4, may prevent the occurrence of the toggle phenomenon that may be caused by a path delay that varies for each input path when the 1-bit Wallace tree 307 is used.

FIG. 3C illustrates an example timing of a multi-bit accumulator, according to one or more example embodiments. FIG. 3C shows a timing between a clock signal CLK 301, a signal IN 305, an enable signal EN 340, and an output Y 350 of the multi-bit accumulator 300.

The clock signal CLK 301 may correspond to a frequency of a system clock. The clock signal CLK 301 may, for example, branch four times at a maximum of 700 Mhz, but is not limited thereto. The clock signal CLK 301 may be generated, for example, a number of times corresponding to a multiple (e.g., 1.5 times) of the number N of memory arrays including bit cells.

The signal IN 305 may correspond to a 1-cycle enable signal of the clock signal CLK 301.

The enable signal EN 340 may enable the tristate logic circuit(s) 130. The enable signal EN 340 may be generated as a signal generator (e.g., the signal generator 170 of FIG. 1) inverts the clock signal CLK 301.

The multi-bit accumulator 300 may cause a Wallace tree 110 (“WT” as illustrated) to operate when the enable signal EN 340 is equal to “0” as shown in FIG. 3C, and may cause the shift-adder 150 (or “S-A” as illustrated) to operate when the enable signal EN 340 is equal to “1.”

In addition, when the enable signal EN 340 is equal to “1,” outputs of the tristate logic circuits 130 may be transferred to the shift-adder 150. In this case, the outputs of the tristate logic circuits 130, which are routed in an actual chip, may generate a parasitic capacitance including an input capacitance of the shift-adder 150. In this case, data may be stored in the generated parasitic capacitance, which may be used to allow the shift-adder 150 to perform in a pipeline fashion.

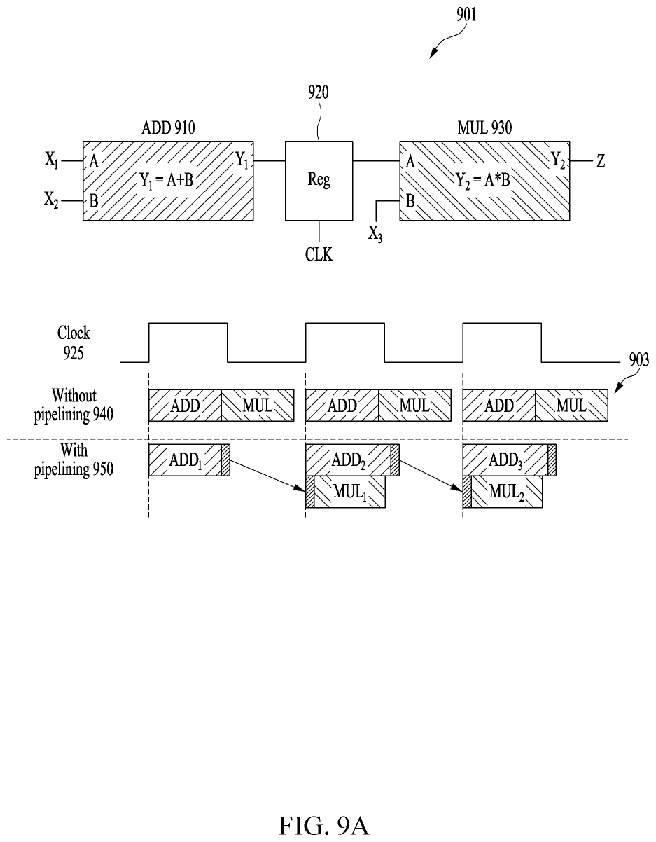

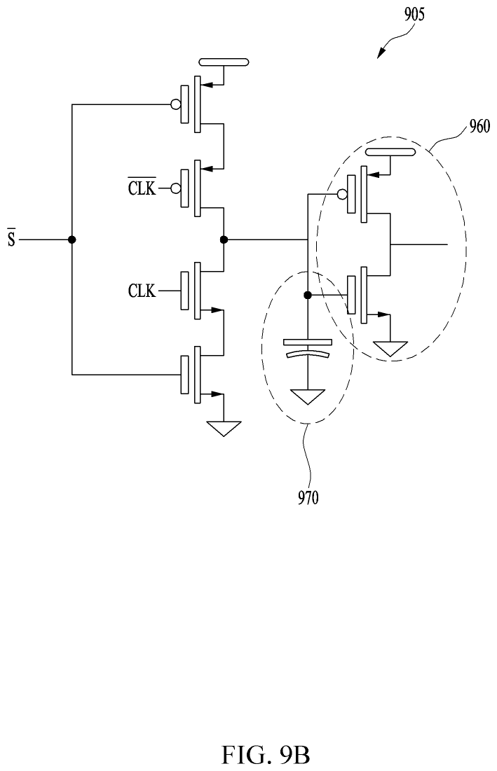

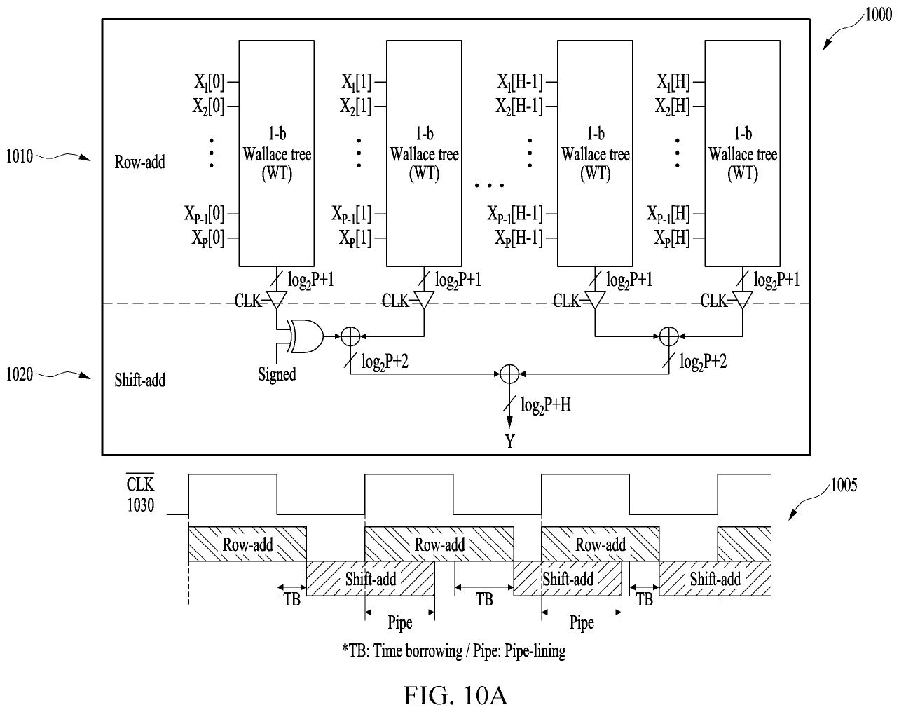

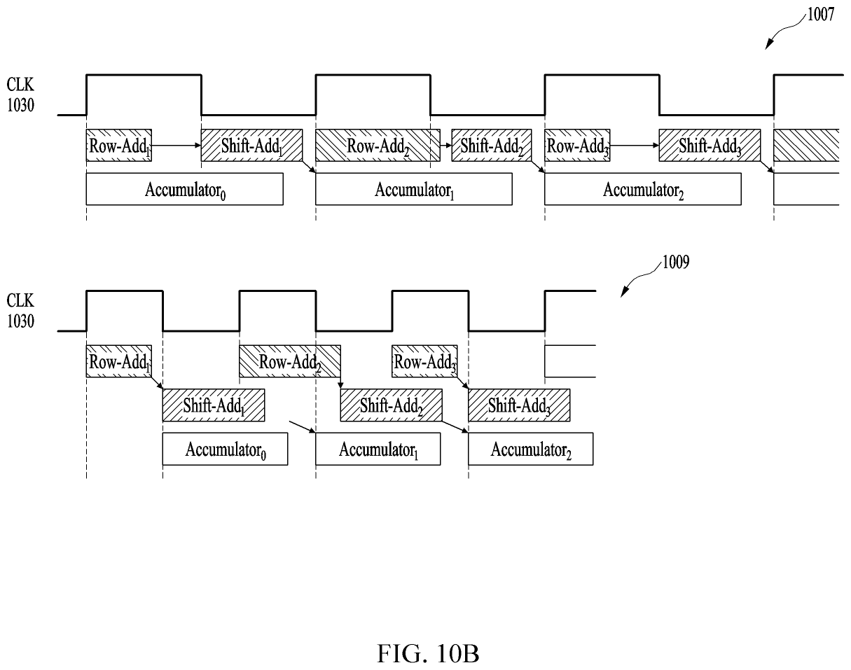

The multi-bit accumulator 300 may reduce the number of full adders corresponding to various numbers of pieces (e.g., P number of pieces) of 4-bit input data for signed data, which is described below, through the pipelining operation of the shift-adder 150 and may, at the same time, improve speed with the pipelining operation. The pipelining operation is described with reference to FIGS. 9A to 10B.

FIG. 4 illustrates an example operation of a tristate logic circuit, according to one or more example embodiments. FIG. 4 includes a diagram 400 illustrating an operation of one of the tristate logic circuits 130 (e.g., a tristate buffer). Although an example case in which a tristate logic circuit is a tristate buffer is described below, examples are not limited thereto.

The diagram 400 illustrates an operation performed when an enable signal EN is applied to a tristate buffer(s). A diagram 430 illustrates an operation performed when an enable signal EN is applied to an inverted tristate buffer.

For example, as shown in the table 420 associated with the diagram 410, when the enable signal EN of “0” is applied to the tristate buffer, the tristate buffer outputs a high-impedance state (or “Hi-Z” as illustrated), regardless of the input data. Alternatively, when the enable signal EN of “1” is applied, the tristate buffer may output a value of input data A as-is.

Alternatively, as shown in the table 440 associated with the diagram 430, when the enable signal EN of “0” is applied to the inverted tristate buffer, the tristate buffer may output a value of input data A. Alternatively, when the enable signal EN of “1” is applied, the tristate buffer may output a high-impedance state (or “Hi-Z” as illustrated), regardless of the input data A.

To summarize, when an enable signal EN has a second logical value (e.g., 1) that is the inverse of a first logical value, the tristate logic circuits 130 output an add operation result of the 1-bit Wallace trees 110 to the shift-adder 150 and, when the enable signal EN has the first logical value (e.g., 0), the tristate logic circuits 130 output a high impedance state such that an add operation result of a previous stage (or phase) is maintained until all add operation results of the 1-bit Wallace trees 110 arrive.

In an example embodiment, as the add operation result of the previous stage (or phase) is not transferred to the shift-adder 150 until all the add operation results of the 1-bit Wallace trees 110 arrive, a toggling phenomenon that may occur in an output of the 1-bit Wallace trees 110 may be prevented, and power consumption for such an unnecessary toggling phenomenon may be reduced.

FIG. 5 illustrates example structure of a multi-bit accumulator configured to perform a signed operation, according to one or more example embodiments. FIG. 5 shows example structure of a multi-bit accumulator 500 configured to perform a signed operation. The multi-bit accumulator 500 has a similar structure to that of the multi-bit accumulator 300 described above, and thus a description of components that are redundant with the multi-bit accumulator 300 is omitted.

For example, the multi-bit accumulator 500 may perform a signed operation on signed data. In this case, the multi-bit accumulator 500 may further include a logic gate 510 that performs a logical operation between the signed data and an MSB among accumulation operation results of the shift-adder 150. The logic gate 510 may be, for example, an XOR gate that performs an XOR operation between the MSB and the signed data as shown in FIG. 6 but is not limited thereto.

In an example, the logic gate 510 may perform an XOR logic operation on an MSB part among accumulation operation results of the shift-adder 150 so as to perform a signed operation and may reduce the number of full adders used for the signed operation.

FIG. 6 illustrates an example structure of a multi-bit accumulator including an adder array according to one or more example embodiments. FIG. 6 shows a structure of a multi-bit accumulator 600 including an adder array.

The multi-bit accumulator 600 may include an adder array 630 that includes full adders used in a final operation stage among a plurality of operation stages for an add operation in each of the 1-bit Wallace trees 110. The tristate logic circuits 130 described above may be embedded for an individual adderAdd_{LST} 635 of the adder array 630.

For a two's complement operation on the multi-bit accumulator 600, a negative operation on signed data of an MSB corresponding to the final operation stage may be implemented by an XOR gate 610. A structure and circuit of the Add_{LST} 635 is described with reference to FIGS. 7 and 8.

FIG. 7 illustrates an example circuit of an adder array, according to one or more example embodiments, and FIG. 8 illustrates an example circuit of a first-type full adder and a second-type full adder included in an adder array, according to one or more example embodiments.

FIG. 7 shows a circuit 700 of an individual adderAdd_{LST} 635 included in an adder array 630. In addition, FIG. 8 shows a circuit 800 of a first-type full adder FA_{S} 710 and a second-type full adder FA_{S&C} 730 included in the individual adderAdd_{LST} 635.

The individual adderAdd_{LST} 635 included in the adder array 630 may include the first-type full adder FA_{S} 710 in which a tristate logic circuit 720 is connected to an add operation result S (among pieces of 1-bit input data), and the second-type full adder FA_{S&C} 730 in which the tristate logic circuit 720 is connected to each of an add operation result S (corresponding to an operation result of a final operation stage) and to a carry operation result C generated in response to an add operation result S (corresponding to the operation result of the final operation stage).

The individual adderAdd_{LST} 635 may be, for example, a circuit in which the tristate logic circuit 720 is added to outputs of a full adder FA in the form of a log₂P-bit ripple carry adder. For example, where the full adders and the tristate logic circuit 720 are separately designed and attached to each other, the number of used transistors may increase. In an example, as illustrated in FIG. 8, the tristate logic circuit 720 may be included in the individual adderAdd_{LST} 635 without a loss of a large area by adding, to a full adder (e.g., a full adder 811 or a full adder 831) as shown in FIG. 8, tristate logic circuits 813, 833, and 835 (each including two transistors or four transistors).

Referring to FIG. 8, the first-type full adder FA_{S} 710 may have a form in which the tristate logic circuit 813 is connected to an add operation result S among pieces of single-bit input data by the full adder 811. The second-type full adder FA_{S&C} 730 may have a form in which the tristate logic circuit 833 is connected to an add operation result S (corresponding to an operation result of the full adder 831 in a final operation stage) and the tristate logic circuit 835 is connected to a carry operation result C generated in response to an add operation result S of the full adder 831 in the final operation stage. The second-type full adder FA_{S&C} 730 may output an operation result of an MSB of the final operation stage.

FIG. 9A illustrates an example pipelining operation of a multi-bit accumulator to which a tristate logic circuit is applied, according to one or more example embodiments. Referring to FIG. 9, it is assumed that there is an operation device 901 including a block 910 performing an add operation (ADD) and a block 930 performing a multiplication operation (MUL). A timing diagram 903 illustrates a method by which an input is provided to each block according to a clock (CLK) 925 of the operation device 901. In this case, at a rising edge of the clock 925, an input may be applied to each of the blocks 910 and 930.

The block 910 may perform an add operation (i.e., A+B) on inputs (X₁, X₂). For example, the block 910 may correspond to the 1-bit Wallace trees 110 but is not limited thereto.

The block 930 may perform a multiplication operation on an add operation result obtained from the add operation (A+B) and an input X₃. For example, the block 930 may correspond to the shift-adder 150 but is not limited thereto.

In this case, an operation of each block of the operation device 901 may vary according to whether a register 920 that stores the add operation result of the block 910 is included between the block 910 and the block 930.

For example, in the case of no pipelining, when the operation device 901 does not include the register 920, the block 930 may perform the multiplication operation by receiving the add operation result of the block 910 as shown in the “without pipelining” timing diagram 940. In this example, the inputs for the blocks 910 and 930 are sequentially provided to the block 910 and the block 930 within one clock, which corresponds to a case that does not use a pipelining method. Thus, there may be a delay until the block 930 receives the add operation result of the block 910, and such a delay may be repeated each operation, creating significant cumulative delay.

In contrast, in the case of pipelining, when the operation device 901 includes the register 920, the add operation result of the block 910 may be stored in the register 920, and the block 930 may perform the multiplication operation by receiving a value stored in the register 920 instead of a value output directly from the block 910. In this case, the inputs for the blocks 910 and 930 may be simultaneously provided within one clock, which corresponds to a case that uses pipelining. Therefore, when a pipelining operation is performed as shown in the “with pipelining” timing diagram 950, the block 930 may perform an operation simultaneously as the block 910 performs an operation without a need to wait to receive the add operation result of the block 910.

FIG. 9B illustrates an example situation in which a parasitic capacitance is generated in a multi-bit accumulator, according to one or more example embodiments. Referring to FIG. 9B, a diagram 905 illustrates a situation in which, when two transistors 960 are added to the multi-bit accumulator 300, a parasitic capacitance 970 for performing the function of a register, e.g., “holding” data, (described above) is generated. A broken line indicating the parasitic capacitance 970 symbolically illustrates the parasitic capacitance 970 as a physical circuit element, although it is not an actual circuit element.

For example, when an output of the tristate logic circuits 130 of the multi-bit accumulator 300 is routed in an actual chip, the parasitic capacitance 970 (including an input capacitance of the shift-adder 150) may be generated. In this case, as data is effectively stored (maintained) in the generated parasitic capacitance 970, a pipelining operation may be performed in the shift-adder 150. A state in which the parasitic capacitance 970 is charged may be “1,” and a state in which the parasitic capacitance 970 is discharged may be “0.”

In an example, during a period of time when a value (e.g., “1”) charged in the parasitic capacitance 970 is maintained even though a connection is instantaneously released, the value of the parasitic capacitance 970 may be used, functionally, as a latch. A latch is a logic circuit that maintains a current state until an input signal for changing the state is generated, as long as the power is supplied. A latch may have an output value that changes according to a change in an input value only when a clock is high or low.

The register 920 may store an output value of each of the 1-bit Wallace trees 110 according to a clock signal for the pipelining operation between the 1-bit Wallace trees 110 and the shift-adder 150, and transmit the output value to the shift-adder 150. The register 920 may be implemented by the parasitic capacitance 970 generated by the tristate logic circuits 130. In an example, as the parasitic capacitance 970 performs the function of the register 920 described above, the multi-bit accumulator 300 may perform the pipelining operation without an additional device. The parasitic capacitance 970 may undesirably experience leakage in a low-speed circuit, and thus the multi-bit accumulator 300 may be driven with a high-speed clock signal that is sufficient to prevent an amount of electric charge charged in the parasitic capacitance 970 from being depleted by leakage.

The multi-bit accumulator 300 may reduce the number of full adders corresponding to various numbers (e.g., P) of 4-bit input data for signed input data through the pipelining operation in the shift-adder 150, while improving the speed along with the pipelining operation.

FIG. 10A illustrates an example of performing a row-add operation by a Wallace tree and a shift-add operation by a shift-adder through pipelining in a multi-bit accumulator, according to one or more example embodiments.

Referring to FIG. 10A, diagram 1000 illustrates 1-bit Wallace trees 1010 performing a row-add operation in the multi-bit accumulator 300 and a shift-adder 1020 performing a shift-add operation in the multi-bit accumulator 300. A timing diagram 1005 illustrates a process of performing a pipelining operation between the row-add operation and the shift-add operation.

For example, referring to the timing diagram 1005, the 1-bit Wallace trees 1010 may perform the row-add operation at a rising edge of a clock signal 1030, and the shift-adder 1020 may perform the shift-add operation at a falling edge of the clock signal 1030.

The multi-bit accumulator 300 may input, to the 1-bit Wallace trees 1010, input data according to the rising edge of the clock signal 1030 in the timing diagram 1005 to allow them to perform the row-add operation, thereby preventing a toggling phenomenon described above and reducing power consumption. In this case, the length of the input data applied to the 1-bit Wallace trees 1010 may be changed for each clock signal 1030 in the timing diagram 1005, and this may indicate a time used for the row-add operation has changed according to a pattern (e.g., the number of “1”s) of the input data.

The row-add operation may be started according to the rising edge of the clock signal 1030 but may be ended after a predetermined period of time elapses at the falling edge of the corresponding clock signal (e.g., a first clock signal), rather than be ended immediately according to the falling edge of the clock signal. In this case, the predetermined period of time may correspond to time borrowing (TB). The TB is a time secured through a TB method used for a latch-based digital circuit. The TB may correspond to an attribute of a latch that allows a path ending at the latch to borrow a time from a next path in a pipeline such that a total time of the two paths is maintained the same. The time borrowed by the latch in a next step of the pipeline may be subtracted from the time in the next path. Such a TB attribute of the latch stems from the latch being sensitive to the signal level. Therefore, the multi-bit accumulator 300 may capture data during a time in a certain range rather than only a single time slot.

Since the shift-adder 1020 may operate according to the falling edge of the clock signal 1030, the multi-bit accumulator 300 may not allow the shift-adder 1020 to exceed a falling edge of a second clock signal in the timing diagram 1005 for the shift-add operation. In this case, the pipelining operation may be performed during a time from a rising edge of the second clock signal to the end of the shift-add operation.

FIG. 10B illustrates an example clock control operation performed when a multi-bit accumulator operates in a toggle prevention mode and in a pipeline mode, according to one or more example embodiments. Referring to FIG. 10B, timing diagram 1007 illustrates clock control performed when the multi-bit accumulator 300 operates in a toggle prevention mode, and a timing diagram 1009 illustrates clock control performed when the multi-bit accumulator 300 operates in a pipeline mode. An accumulator illustrated in FIG. 10B may correspond to the accumulator and output register 240 described above with reference to FIG. 2A.

The multi-bit accumulator 300 may operate in the toggle prevention mode without a pipelining operation as illustrated in the timing diagram 1007, or it may operate in the pipeline mode as illustrated in the timing diagram 1009. The modes may be controlled by adjusting an operation time of the accumulator.

The multi-bit accumulator 300 may prevent a toggling phenomenon by outputting an output value Y of the multi-bit accumulator 300 through the accumulator according to a rising edge of a clock signal 1030, as illustrated in the timing diagram 1007.

Referring to the timing diagram 1007, a row-add operation may be started at the rising edge of the clock signal 1030, and a shift-add operation may be started at a falling edge of the clock signal 1030.

In addition, the multi-bit accumulator 300 may perform the pipelining operation while preventing the toggling phenomenon by outputting an output value Y of the multi-bit accumulator 300 through the accumulator according to the falling edge of the clock signal 1030, as illustrated in the timing diagram 1009.

For example, when the row-add operation is ended after the falling edge of the clock signal 1030, as in Row-Add₂, in the timing diagram 1007 and the timing diagram 1009, the multi-bit accumulator 300 may perform the shift-add operation from a time at which the row-add operation is ended.

To summarize, the multi-bit accumulator 300 may adjust the output Y of the multi-bit accumulator 300 to be output after one clock according to the rising edge of the clock signal 1030 (as illustrated in the timing diagram 1007), thereby preventing the toggling phenomenon and reducing power consumption. Alternatively, the multi-bit accumulator 300 may adjust the output Y of the multi-bit accumulator 300 to be output after 1.5 clocks according to the falling edge of the clock signal 1030 (as illustrated in the timing diagram 1009), thereby improving the speed of the operation of the multi-bit accumulator 300 through the pipelining operation.

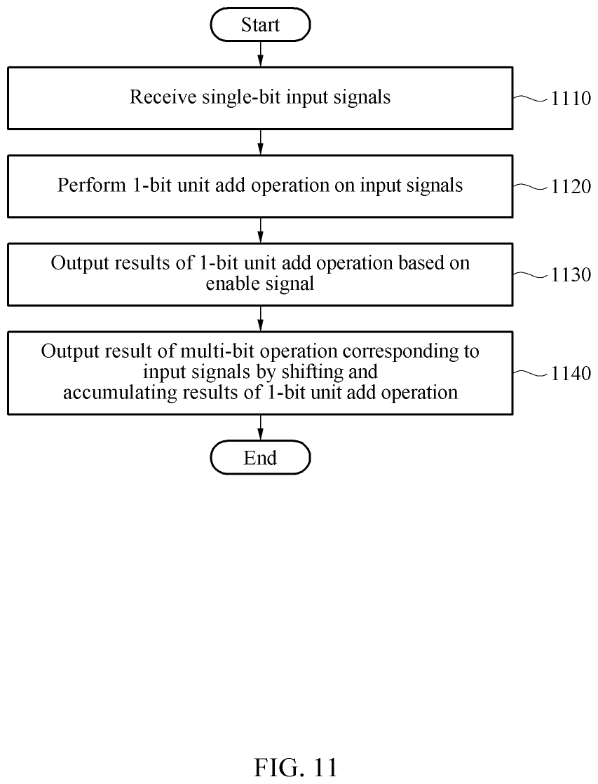

FIG. 11 illustrates an example method of operating a multi-bit accumulator according to one or more example embodiments.

Referring to FIG. 11, a multi-bit accumulator (e.g., the multi-bit accumulator 100 of FIG. 1) according to an example embodiment may output a multi-bit operation result corresponding to single-bit input signals through operations 1110 to 1140.

In operation 1110, the multi-bit accumulator may receive pieces of single-bit input data.

In operation 1120, the multi-bit accumulator may perform a 1-bit unit add operation on the input data received in operation 1110.

In operation 1130, the multi-bit accumulator may output results of the 1-bit unit add operation performed in operation 1120, based on an enable signal. For example, when the enable signal has a first logical value (e.g., “0”), the multi-bit accumulator may output a high-impedance state. When the enable signal has a second logical value (e.g., “1”) opposite to the first logical value, the multi-bit accumulator may output an add operation result of 1-bit Wallace trees to a shift-adder.

In operation 1140, the multi-bit accumulator may output a multi-bit operation result corresponding to the input data by shifting and accumulating the results of the 1-bit unit add operation output in operation 1130.

For example, when the multi-bit accumulator performs a signed operation on signed data, the multi-bit accumulator may perform a logical operation (e.g., an XOR logical operation) between the signed data and an MSB in the multi-bit operation result.

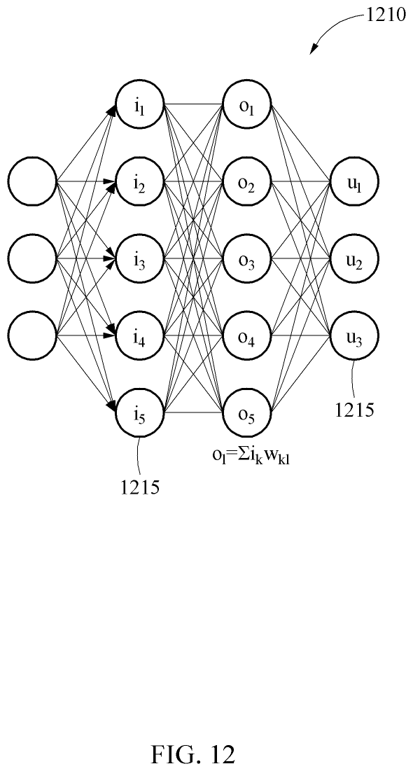

FIG. 12 illustrates an example neural network in which operations are performed in an IMC circuit, according to one or more example embodiments. Referring to FIG. 12, a neural network 1210 is illustrated.

IMC is generally a computing architecture that allows an operation to be performed directly inside a memory in which data is persistently stored (e.g., before, during, and after the operation) to break through performance and power limitations caused by frequent data movements between the memory and an operation unit (e.g., a processor) that occur in a von-Neumann architecture. IMC macros may be divided into an analog IMC macros and digital IMC macros, according to which domain an operation is to be performed. An analog IMC macro may, for example, perform an operation in an analog domain, such as, current, electric charge, time, and the like. A digital IMC macro may use a logic circuit to perform an operation in a digital domain. The description herein relates to a digital IMC circuit.

IMC may accelerate a matrix operation and/or an MAC operation that performs addition of multiple multiplications at a time, which may be general for artificial intelligence (AI) learning and inference. The MAC operation for the learning and inference of the neural network 1210 may be performed through a memory array, and the memory array may include bit cells of a memory device in the IMC macro. Hereinafter, an example case in which the neural network 1210 includes fully connected layers will be described for the convenience of description, but examples are not limited thereto. The neural network 1210 may be a convolutional neural network (CNN) including convolution layers, for example. The IMC circuit may perform the MAC operation through an operation function performed by the memory array including the bit cells, thus enabling efficient machine learning and inference of the neural network 1210.

The neural network 1210 may be, for example, a deep neural network (DNN) or an n-layer neural network including two or more hidden layers. The neural network 1210 may be, for example, a DNN including an input layer (Layer 1), two hidden layers (Layer 2 and Layer 3), and an output layer (Layer 4), but is not limited thereto. For example, when the neural network 1210 is implemented in a DNN architecture, the neural network 1210 may include a greater number of layers that may process valid information and may thus process more complex data sets than a neural network having a single layer. Although the neural network 1210 is illustrated as including four layers, this is provided only as an example, and the neural network 1210 may include fewer or more layers or channels. That is, the neural network 1210 may include layers of various structures different from one illustrated in FIG. 12.

Each of the layers included in the neural network 1210 may include a plurality of nodes 1215. A node may correspond to a processing element (PE), a unit, a channel, or a unit that is known as similar terms. The example neural network 1210 includes, for example, an input layer including three nodes, hidden layers each including five nodes, and an output layer including three nodes, but is not limited thereto. However, the neural network 1210 illustrated in FIG. 12 is provided only as an example, and each of the layers included in the neural network 1210 may include various numbers of nodes. The nodes 1215 included in each of the layers of the neural network 1210 may be connected to one another to process data. For example, one node may receive data from other nodes to perform an operation and may output a result of the operation to other nodes.

A plurality of nodes 1215 of one layer may be connected to nodes of another layer through a connection line, and a weight w may be set for the connection line. For example, an output o₁ of one node may be determined based on input values (e.g., i₁, i₂, and i₃) propagated from other nodes of a previous layer connected to the node and on weights (e.g., w₁₁, w₂₁, w₃₁, and w₄₁) of connection lines of the node.

For example, an lth output oₗ among L output values may be expressed by Equation 2 below. In this example, “L” may be an integer greater than or equal to “1” and “l” may be an integer greater than or equal to “1” and less than or equal to “L.”.

oₗ=Σiₖwₖₗ Equation 2

In Equation 2, iₖ may denote a kth input among P inputs, and wₖₗ may denote a weight set between the kth input and the lth output. “P” may be an integer greater than or equal to “1,” and “k” may be an integer greater than or equal to “1” and less than or equal to “P.”

That is, the input and output between the nodes 1215 in the neural network 1210 may be expressed as a weighted sum between the input (i) and the weight (w). The weighted sum may also be referred to as an MAC operation which is a multiplication operation and an iterative accumulation operation between a plurality of inputs and a plurality of weights. Since the MAC operation is performed using a memory to which an operation function is added, a circuit on which the MAC operation is performed may be referred to as an “IMC macro.”

For example, the neural network 1210 may perform a weighted sum operation in layers based on input data (e.g., i₁, i₂, i₃, i₄, and i₅) and generate output data (e.g., u₁, u₂, and u₃) based on a result (e.g., o₁, o₂, o₃, o₄, and o₅) of performing the operation.

FIG. 13 illustrates an example IMC processor including a multi-bit accumulator, according to one or more example embodiments. Referring to FIG. 13, an IMC processor 1300 according to an example embodiment may include an input controller 1310, an IMC device 1330 including a plurality of IMC macros 1330-1, and a post operation circuit 1350.

The input controller 1310 may sequentially input multi-bit first values to the IMC device 1330 bit by bit. The first values may correspond to input data or weight data, for example.

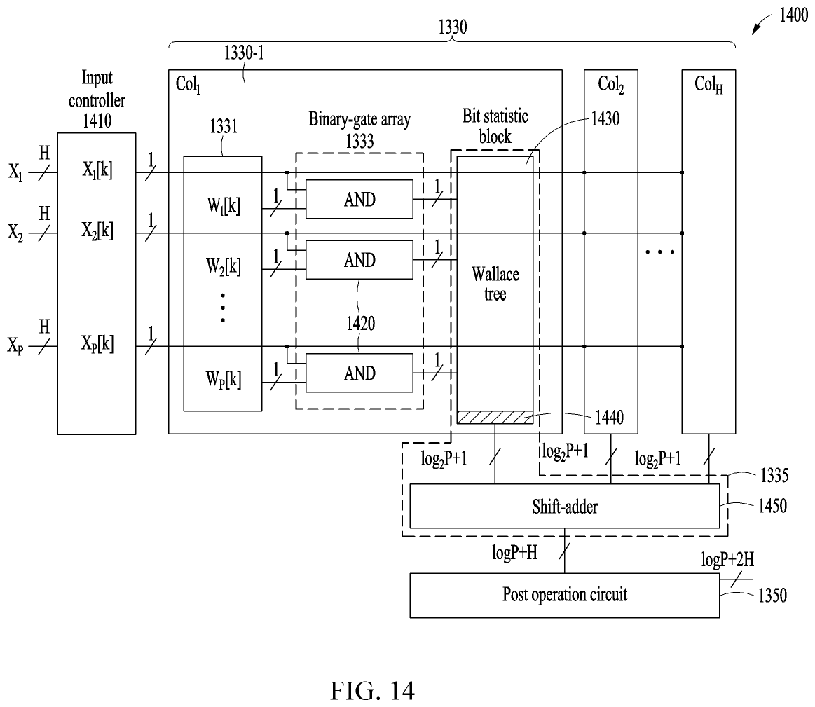

The IMC device 1330 may include, for example, the plurality of IMC macros 1330-1 including a plurality of columns Col₁, Col₂, . . . , and Col_{H} in a cross-bar structure, as illustrated in FIG. 14.

Each of the IMC macros 1330-1 may include a memory array 1331, a binary gate array 1333, and a multi-bit accumulator 1335. Each of the IMC macros 1330-1 may include memory banks of a plurality of memory arrays 1331.

The memory array 1331 may include bit cells that store a second value applied to each of the first values. The second value may correspond to weight data or input data, for example. The memory array 1331 may include a plurality of bit cells. The bit cells connected to the same bit lines of the memory array 1331 may receive the same single-bit (or 1-bit) data.

The memory array 1331 may include a plurality of word lines, a plurality of bit lines intersecting with the plurality of word lines, and a plurality of bit cells disposed at intersecting points between the plurality of word lines and the plurality of bit lines. For example, the memory array 1331 may include 64 word lines and 64 bit lines. In this example, the size of the memory array 1331 may be expressed as 64×64. The word lines and the column lines in the memory array 1331 may be implemented by changing one another. However, examples are not necessarily limited thereto.

The binary gate array 1333 may include operation gates that perform a single-bit binary operation or an MAC operation between the first values and the second value. The operation gates may be, for example, an AND gate but are not limited thereto.

The multi-bit accumulator 1335 may perform a bit-wise operation on a result of the single-bit binary operation or a result of the MAC operation of the binary gate array 1333 and may perform an accumulation operation on an operation result corresponding to any one of the columns through a shift operation based on a clock signal.

The multi-bit accumulator 1335 may include 1-bit Wallace trees (e.g., the Wallace trees 110 of FIG. 1, 3A, 5, or 6), tristate logic circuits (e.g., the tristate logic circuits 130 of FIG. 1, 3A, 5, or 6), and a shift-adder (e.g., the shift-adder 150 of FIG. 1, 3A, 5, or 6).

The 1-bit Wallace trees may perform a bit-wise operation on single-bit MAC operation results. Each of the 1-bit Wallace trees may include an adder array including full adders used in a final operation stage among a plurality of operation stages for an add operation. The adder array may include first-type full adders in which a tristate logic circuit is connected to the single-bit MAC operation results, and a second-type full adder in which a tristate logic circuit is connected to an add operation result (e.g., sum) corresponding to an operation result of the final operation stage and to a carry operation result generated in response to the add operation result.

The tristate logic circuits may output the bit-wise operation result of the 1-bit Wallace trees, according to an enable signal. When the enable signal has a first logical value (e.g., 0), the tristate logic circuits may output a high-impedance state and, when the enable signal has a second logical value (e.g., 1) opposite to the first logical value, the tristate logic circuits may output the bit-wise operation result of the 1-bit Wallace trees to the shift-adder.

The shift-adder may perform an accumulation operation on an add operation result of the 1-bit Wallace trees corresponding to any one of the columns by a shift operation, based on a clock signal. The 1-bit Wallace trees may operate according to an enable signal having a first logical value (e.g., 0), and the shift-adder may operate according to an enable signal having a second logical value (e.g., 1) opposite to the first logical value.

The multi-bit accumulator 1335 may correspond to, but is not limited to, the multi-bit accumulator illustrated in FIG. 1, 3A, 5, or 6. For example, when the multi-bit accumulator 1335 performs a signed operation on signed data, the multi-bit accumulator 1335 may include a logic gate that performs a logical operation between the signed data and an MSB in an accumulation operation result. The logic gate may be, for example, an XOR gate that performs an XOR operation between the MSB and the signed data but is not limited thereto.

The multi-bit accumulator 1335 may further include a signal generator that generates an enable signal for enabling the tristate logic circuits by inverting a clock signal.

The post operation circuit 1350 may output a multi-bit operation result that integrates operation results of the plurality of IMC macros 1330-1. A detailed configuration of the post operation circuit 1350 is described below with reference to FIG. 14.

FIG. 14 illustrates example structure of an IMC processor, according to one or more example embodiments. Referring to FIG. 14, an example structure of an IMC processor 1400 is illustrated.

The IMC processor 1400 may correspond to, for example, the IMC processor 1300 described above with reference to FIGS. 13, but is not necessarily limited thereto.

The IMC processor 1400 may include an input controller 1410, an IMC device 1330 including a plurality of IMC macros 1330-1, and a post operation circuit 1350.

The input controller 1410 may sequentially input multi-bit first values to the IMC device 1330 bit by bit. The input controller 1410 may apply P number of H-bit first values X₁ to X_{P} to each column of the IMC device 1330. That is, the input controller 1410 may sequentially apply the P H-bit first values X₁ to X_{P} to each of the IMC macros 1330-1, one bit at a time according to a time sequence. In this case, the first values may correspond to input data or weight data, for example.

The IMC device 1330 may include, for example, a plurality of IMC macros 1330-1 including a plurality of columns Col₁, Col₂, . . . , and Col_{H} in a cross-bar structure, as illustrated in FIG. 14.

Each of the IMC macros 1330-1 may include a memory array 1331, a binary gate array 1333, and a multi-bit accumulator 1335. Each of the IMC macros 1330-1 may include memory banks of a plurality of memory arrays 1331.

The memory array 1331 may include bit cells that store P number of second values (e.g., W₁ to W_{P}) to which the P first values (e.g., X₁ to X_{P}) are applied, respectively. The second values may correspond to weight data W or input data X, for example. The memory array 1331 may have, for example, the same form as the memory array 1230 of FIG. 12 but is not limited thereto.

The binary gate array 1333 may include operation gates that perform a single-bit binary operation or an MAC operation between the first values input by the input controller 1410 through a 1-bit gate and the second values stored in the memory array 1331. The operation gates may be, for example, an AND gate 1420, but are not limited thereto. The operation gates may correspond to a 1-bit multiplication operation.

The multi-bit accumulator 1335 may perform statistical processing on single-bit MAC operation results (e.g., P MAC operation results s₁ to s_{P}) output through the binary gate array 1333. The “statistical processing” may be, for example, a count on the number of “1”s or the number of “0”s among the single-bit MAC operation results s₁ to s_{P} and/or a bit-wise operation on the single-bit MAC operation results ₛ₁ to _{SP}, but is not necessarily limited thereto. The statistical processing may be performed by, for example, a 1-bit adder tree including full adders, but is not necessarily limited thereto. The 1-bit adder tree may be implemented, for example, in the form of a Wallace tree described above.

The multi-bit accumulator 1335 may include Wallace trees 1430, tristate logic circuits 1440, and a shift-adder 1450. The Wallace trees 1430 and the tristate logic circuits 1440 may correspond to a bit statistic block that performs the statistical processing described above.

The shift-adder 1450 may combine operation results corresponding to any one of N columns through a shift operation and an add operation based on a clock signal. The shift-adder 1450 may correspond to, for example, the shift-adder 150 described above with reference to FIG. 1.

For example, the shift-adder 1450 may perform a shift operation and an add operation on a bit-wise operation result (e.g., a log₂ P+1 bit) corresponding to any one of H columns. The shift-adder 1450 may output the bit-wise operation result (e.g., a log₂ P+H bit) corresponding to the N columns through the shift operation and the add operation. The shift-adder 1450 may be shared by each column, as illustrated in FIG. 14, or may be provided separately for each column.

The post operation circuit 1350 may combine outputs O₁ to O_{N} of the N columns into one and output them as a multi-bit MAC operation result. In this case, the multi-bit MAC operation result may be a log₂ P+2H bit.

For example, the post operation circuit 1350 may receive outputs of H IMC macros 1330-1 and perform a shift operation and an accumulation. The post operation circuit 1350 may perform the shift operation on partial sums corresponding to respective MAC operation results of the H IMC macros 1330-1, and accumulate shift operation results. The post operation circuit 1350 may store a log₂ P+2H bit accumulation result in, for example, a buffer and/or an output register, but is not limited thereto.

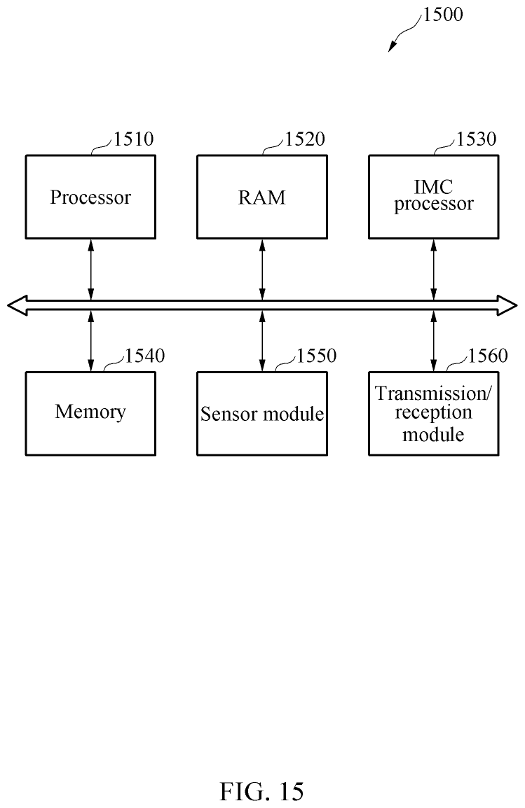

FIG. 15 illustrates an example electronic system including an IMC processor, according to one or more example embodiments. Referring to FIG. 15, an electronic system 1500 may analyze input data in real time based on a neural network (e.g., the neural network 1210 of FIG. 12) and extract valid information, determine a situation based on the extracted information, or control components of an electronic device on which the electronic system 1500 is provided. For example, the electronic system 1500 may be applied to a mobile device, a mobile computing device, a mobile phone, a smartphone, a personal digital assistant (PDA), a fixed location terminal, a tablet computer, a computer, a wearable device, a laptop computer, a server, a music player, a video player, an entertainment unit, a navigation device, a communication device, an Internet of Things (IoT) device, a global positioning system (GPS) device, a television (TV), a tuner, a vehicle, a vehicle part, an avionics system, a drone, a multicopter, an electric vertical takeoff and landing (eVTOL) aircraft, and a medical device, and may be mounted on at least one of other various types of electronic devices.

The electronic system 1500 may include a processor 1510, random-access memory (RAM) 1520, an IMC processor 1530, a memory 1540, a sensor module 1550, and a transmission/reception module 1560. The electronic system 1500 may further include an input/output module, a security module, a power control device, and the like. Some of the hardware components of the electronic system 1500 may be mounted on at least one semiconductor chip.

The processor 1510 may control the overall operation of the electronic system 1500.

The processor 1510 may include one processor core (e.g., single-core) or a plurality of processor cores (e.g., multi-core). The processor 1510 may process or execute programs and/or data stored in the memory 1540. The processor 1510 may control a function of the IMC processor 1530 by executing programs stored in the memory 1540. The processor 1510 may be implemented as a central processing unit (CPU), a graphics processing unit (GPU), an application processor (AP), and the like.

The RAM 1520 may temporarily store programs, data, or instructions. For example, the programs and/or data stored in the memory 1540 may be temporarily stored in the RAM 1520 according to the control or booting code of the processor 1510. The RAM 1520 may be implemented as, for example, a memory such as dynamic RAM (DRAM) or static RAM (SRAM).

The IMC processor 1530 may perform an operation of a neural network (e.g., the neural network 1210 of FIG. 12) based on received input data, and generate various information signals based on a result of performing the operation. The neural network may include, as non-limiting examples, a convolution neural network (CNN), a recurrent neural network (RNN), a fuzzy neural network (FNN), a deep belief network (DBN), or a restricted Boltzmann machine (RBM), and the like. The IMC processor 1530 may be, for example, a hardware accelerator itself dedicated to the neural network and/or a device including the neural network. The information signals may include, for example, one of various types of recognition signals, such as, a speech recognition signal, an object recognition signal, a video recognition signal, and a biological information recognition signal.

The IMC processor 1530 may control SRAM-bit cell circuits of an IMC macro (e.g., the IMC macros 1330-1 in FIG. 13) to share and/or process the same input data and select at least some of operation results output from the SRAM-bit cell circuits.

The IMC processor 1530 may be, for example, the IMC processor 1400 of FIG. 14 but is not necessarily limited thereto.

For example, the IMC processor 1530 may receive or store, as input data, frame data included in a video stream and generate a recognition signal for an object included in an image represented by the frame data from the frame data. Alternatively, the IMC processor 1530 may receive various types of input data and generate a recognition signal according to the input data, based on a type or function of the electronic system 1500 on which the IMC processor 1530 is provided.

The memory 1540, which is a storage configured to store data, may store an operating system (OS), various types of programs, and various types of data. In an example embodiment, the memory 1540 may store intermediate results generated during an operation of the IMC processor 1530.

The memory 1540 may include at least one of a volatile memory or a non-volatile memory. The non-volatile memory may include, as non-limiting examples, read-only memory (ROM), programmable ROM (PROM), erasable PROM (EPROM), electrically EPROM (EEPROM), flash memory, magnetic RAM (MRAM), phase-change memory (PCM) RAM (PRAM), resistive RAM (RRAM), and/or ferroelectric RAM (FRAM). The volatile memory may include, as non-limiting examples, DRAM, SRAM, SDRAM, and the like. Depending on examples, the memory 1540 may include at least one of a hard disk drive (HDD), a solid state drive (SSD), a compact flash (CF) card, a secure digital (SD) card, a micro-SD card, a mini-SD card, an extreme digital (Xd) picture card, or a memory stick.

The sensor module 1550 may collect information around the electronic device on which the electronic system 1500 is provided. The sensor module 1550 may sense or receive a signal (e.g., an image signal, a speech signal, a magnetic signal, a biosignal, a touch signal, and the like) from the outside of the electronic system 1500 and convert the sensed or received signal into data. The sensor module 1550 may include at least one of various sensing devices, such as, for example, a microphone, an imaging device, an image sensor, a light detection and ranging (LIDAR) sensor, an ultrasonic sensor, an infrared sensor, a biosensor, and a touch sensor.

The sensor module 1550 may provide the data obtained through the conversion as input data to the IMC processor 1530. For example, the sensor module 1550 may include an image sensor, generate a video stream by capturing an image of an external environment of the electronic system 1500, and provide successive data frames of the video stream as the input data to the IMC processor 1530. However, the sensor module 1550 may not be limited thereto and may provide various types of data to the IMC processor 1530.

The transmission/reception module 1560 may include various types of wired or wireless interfaces configured to communicate with an external device. For example, the transmission/reception module 1560 may include, as non-limiting examples, a wired local area network (LAN), a wireless LAN (WLAN) such as wireless fidelity (Wi-Fi), a wireless personal area network (WPAN) such as Bluetooth, a wireless universal serial bus (USB), ZigBee, near-field communication (NFC), radio-frequency identification (RFID), power line communication (PLC), a communication interface accessible to a mobile cellular network, such as, 3rd generation (3G), 4th generation (4G), and long term evolution (LTE), and the like.

The computing apparatuses, the electronic devices, the processors, the memories, the information output system and hardware, the storage devices, and other apparatuses, devices, units, modules, and components described herein with respect to FIGS. 1-15 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-15 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A multi-bit accumulator comprising:
1-bit Wallace trees each configured to perform an add operation on single-bit input data;
tristate logic circuits each configured to output a result of the add operation of the 1-bit Wallace trees, according to an enable signal provided to the tristate logic circuits; and
a shift-adder configured to perform an accumulation operation on the result of the add operation of the 1-bit Wallace trees by a shift operation based on a clock signal.

2. The multi-bit accumulator of claim 1, wherein each of the 1-bit Wallace trees comprises an adder array comprising full adders, the full adders being used in a final operation stage among operation stages of the add operation,
wherein each adder array comprises:
first-type full adders in which a tristate logic circuit is connected to an add operation result of an add operation between the single-bit input data; and
a second-type full adder in which a tristate logic circuit is connected to each of an add operation result corresponding to an operation result of the final operation stage and a carry operation result generated in response to the add operation result.

3. The multi-bit accumulator of claim 2, wherein each of the tristate logic circuits are configured to:
output a high-impedance state in response to the enable signal having a first logical value; and
output the result of the add operation of the 1-bit Wallace trees to the shift-adder in response to the enable signal having a second logical value that is the inverse of the first logical value.

4. The multi-bit accumulator of claim 1, further comprising a logic gate configured to, in response to the multi-bit accumulator performing a signed operation on signed data, perform a logical operation between the signed data and a most significant bit (MSB) in a result of the accumulation operation of the shift-adder.

5. The multi-bit accumulator of claim 4, wherein the logic gate comprises:
an XOR gate configured to perform an XOR operation between the MSB and the signed data.

6. The multi-bit accumulator of claim 1, further comprising:
a signal generator configured to generate the enable signal by inverting the clock signal.

7. The multi-bit accumulator of claim 1, wherein the 1-bit Wallace trees are configured to operate according to the enable signal having a first logical value, and wherein
the shift-adder is configured to operate according to the enable signal having a second logical value that is the inverse of the first logical value.

8. The multi-bit accumulator of claim 1, further comprising:
registers configured to store output values of the 1-bit Wallace trees, respectively, according to the clock signal, to provide a pipelining operation between the 1-bit Wallace trees and the shift-adder by transmitting the stored output values to the shift-adder.

9. The multi-bit accumulator of claim 8, wherein the plurality of registers is implemented by a parasitic capacitance generated by the tristate logic circuits.

10. The multi-bit accumulator of claim 8, further comprising a multiplier, wherein the transmitting enables the 1-bit Wallace trees to perform the add operation concurrently with a multiplication operation of the multiplier.

11. An in-memory computing (IMC) processor comprising:
an IMC device comprising IMC macros, each IMC macro comprising columns in a cross-bar structure;
an input controller configured to sequentially input multi-bit first values to the IMC device bit by bit; and
a post operation circuit configured to output a multi-bit operation result that integrates operation results of the respective IMC macros,
wherein each of the IMC macros comprises:
a memory array comprising bit cells, each bit cell configured to store a second value applied to each of the first values;
a binary gate array comprising operation gates, each operation gate configured to perform a single-bit multiplication and accumulation (MAC) operation between the first values and the second value; and
a multi-bit accumulator configured to perform a bit-wise operation on results of the single-bit MAC operation and perform an accumulation operation on a result of the bit-wise operation corresponding to any one of the columns.

12. The IMC processor of claim 11, wherein the multi-bit accumulator comprises:
1-bit Wallace trees each configured to perform the bit-wise operation on the results of the single-bit MAC operation;
tristate logic circuits each configured to output a result of the bit-wise operation of a respective one of the 1-bit Wallace trees, according to an enable signal; and
a shift-adder configured to perform an accumulation operation on a result of an add operation of one of the 1-bit Wallace trees corresponding to any one of the columns by the shift operation based on a clock signal.

13. The IMC processor of claim 12, wherein each of the 1-bit Wallace trees comprises:
an adder array comprising full adders used in a final operation stage among operation stages of the add operation,
wherein the adder array comprises:
first-type full adders in which a tristate logic circuit is connected to the results of the single-bit MAC operation; and
a second-type full adder in which a tristate logic circuit is connected to each of an add operation result corresponding to an operation result of the final operation stage and a carry operation result generated in response to the add operation result.

14. The IMC processor of claim 12, wherein each of the tristate logic circuits are configured to:
output a high-impedance state, in response to the enable signal having a first logical value; and
output the result of the bit-wise operation of the 1-bit Wallace trees to the shift-adder in response to the enable signal having a second logical value that is the inverse of the first logical value.

15. The IMC processor of claim 12, further comprising:
a logic gate configured to, based on the multi-bit accumulator performing a signed operation on signed data, perform a logical operation between the signed data and a most significant bit (MSB) in a result of the accumulation operation of the shift-adder.

16. The IMC processor of claim 15, wherein the logic gate comprises:
an XOR gate configured to perform an XOR operation between the MSB and the signed data.

17. The IMC processor of claim 12, further comprising:
a signal generator configured to generate the enable signal that enables the tristate logic circuits by inverting the clock signal.

18. The IMC processor of claim 12, wherein each of the 1-bit Wallace trees is configured to operate according to the enable signal having a first logical value, and wherein
the shift-adder is configured to operate according to the enable signal having a second logical value that is the inverse of the first logical value.

19. The IMC processor of claim 11, wherein the IMC processor is integrated into at least one of: a mobile device, a mobile computing device, a mobile phone, a smartphone, a personal digital assistant (PDA), a fixed location terminal, a tablet computer, a computer, a wearable device, a laptop computer, a server, a music player, a video player, an entertainment unit, a navigation device, a communication device, a global positioning system (GPS) device, a television (TV), a tuner, a vehicle, a vehicle part, an avionics system, a drone, a multicopter, or a medical device.

20. A method of operating a multi-bit accumulator, the method comprising:
receiving single-bit input data;
performing a 1-bit unit add operation on the input data;
outputting results of the 1-bit unit add operation based on an enable signal; and
outputting a result of a multi-bit operation corresponding to the input data by shifting and accumulating the results of the 1-bit unit add operation.
